(19) United States
(12) Patent Application Publication
(10) Pub. No.: US 2026/0065155 A1
(43) Pub. Date: Mar. 5, 2026

(54) DRIFT-BASED FRAMEWORK FOR LIFELONG LEARNING OF LARGE AI SYSTEMS

(71) Applicants: Regents of the University of Minnesota, Minneapolis, MN (US); President and Fellows of Harvard College, Cambridge, MA (US)

(72) Inventors: Jie Ding, Minneapolis, MN (US); Jin Du, Minneapolis, MN (US); Jia Liu, Cambridge, MA (US)

(21) Appl. No.: 19/306,412

(22) Filed: Aug. 21, 2025

Related U.S. Application Data
(60) Provisional application No. 63/690,180, filed on Sep. 3, 2024.

(51) Int. Cl. G06N 20/00; G06F 18/241

(52) U.S. Cl. CPC G06N 20/00; G06F 18/241

(57) ABSTRACT

A computer-implemented method includes receiving data and while using a process that promotes exploration during training, training a new set of model parameters using the received data. The new set of model parameters is used to form a collection of sets of model parameters. Data is separately applied to each set of model parameters in the collection to identify sets of model parameters that perform similarly on the set of data. The sets of model parameters that perform similarly on the data are grouped together in a group of sets of model parameters and test data is applied to groups of sets of model parameters to obtain an uncertainty measure for each group. A group with the lowest uncertainty measure is selected and outputs produced by the sets of model parameters in the selected group are used to generate an output value for the test data.

### CROSS-REFERENCE TO RELATED APPLICATION

The present application is based on and claims the benefit of U.S. provisional patent application Ser. No. 63/690,180, filed Sep. 3, 2024, the content of which is hereby incorporated by reference in its entirety.

This invention was made with government support under W911NF-23-1-0315 awarded by the Army Research Laboratory-Army Research Office, and LM014465 awarded by the National Institutes of Health. The government has certain rights in the invention.

### BACKGROUND

Biological brains exhibit remarkable lifelong learning skills, acquiring new abilities while retaining previously learned information throughout lifetime. In contrast, this lifelong learning capability, known in artificial intelligence (AI) as continual learning, where a system with limited memory can sequentially learn new tasks without forgetting previous ones, remains a significant challenge. The primary issue is catastrophic forgetting, a phenomenon where the performance in previously learned tasks deteriorates significantly as new tasks are learned. This catastrophic forgetting issue limits the lifelong learning capability of current large models, preventing them from evolving over time, especially in applications such as autonomous vehicles, robotics, and natural language processing (NLP).

### SUMMARY

A computer-implemented method includes receiving data and while using a process that promotes exploration during training, training a new set of model parameters using the received data. Placing the new set of model parameters in a collection of previous sets of model parameters to form a new collection of sets of model parameters. A set of data is separately applied to each set of model parameters in the new collection of sets of model parameters to identify sets of model parameters that perform similarly on the set of data. The sets of model parameters that perform similarly on the set of data are grouped together in a group of sets of model parameters and test data is applied to groups of sets of model parameters to obtain an uncertainty measure for each group. A group with the lowest uncertainty measure is selected and outputs produced by the sets of model parameters in the selected group are used to generate an output value for the test data.

In accordance with a further embodiment, a method includes training a new set of model parameters using data for a new task while using a process that promotes exploration during training. The new set of model parameters are combined with prior sets of model parameters to form a group of sets of model parameters, wherein the grouping is based on similarities in performance between the new set of model parameters and the prior sets of model parameters. An input is applied to each set of model parameters in the group of sets of model parameters to produce a set of outputs and the set of outputs are used to determine a final output for the artificial intelligence system.

In accordance with a still further embodiment, a system includes a memory and a processor. The memory contains sets of model parameters and the processor is configured to perform steps. The steps include training a new set of model parameters using data while using a process that promotes exploration during training. The new set of model parameters are grouped with prior sets of model parameters to form a group of sets of model parameters. The grouping is based on similarities in performance between the new set of model parameters and the prior sets of model parameters. An input is applied to each set of model parameters in the group of sets of model parameters to produce a set of outputs and using the set of outputs to determine a final output.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a computing device used to implement the present embodiments.

FIG. 2 is a flow diagram of an exploration stage.

FIG. 3 is a flow diagram of an encoding stage.

FIG. 4 is a flow diagram of a retrieval stage.

FIG. 5a is schematic illustration of stable and drifting networks.

FIG. 5b is a schematic overview showing the three steps of DriftNet: exploration (left), encoding (middle), and retrieval (right).

FIG. 5c is a schematic diagram showing differences during an exploration step between a stable network and a drift network.

FIG. 5d is a schematic diagram showing differences during the encoding step between a stable network and a drift network.

FIG. 5e is a schematic diagram showing differences during the retrieval step between a stable network and a drift network.

FIG. 6a is boxplots with density plots of average test loss, showing the average test loss of two tasks relative to noise scales. The gray dotted line represents the stable baseline.

FIG. 6b shows boxplots with density plots of drift rate, showing the average test loss of two tasks relative to noise scales. The gray dotted line represents the stable baseline. The black line represents the locally weighted scatter plot smoothing (LOWESS) curve of the average test loss with a fraction of 0.3.

FIG. 6c shows a statistical summary of test losses for two tasks relative to epoch for drift (left) and stable (right) networks, respectively.

FIG. 6d shows a statistical summary of training losses with different noise levels (o) relative to the epoch of drift (top) and stable networks (bottom), respectively.

FIG. 6e is scatter dot plots showing the trajectory of two model weights (β1,β2) over time. The top plot contains points over the epoch, (β1,β2,epoch), in 3d space; and the bottom plot contains (β1,β2) data for all epochs.

FIG. 6f is a boxplot showing the drift rates relative to noise levels.

FIG. 6g is scatter dot plots showing performance vectors of minima mapped onto the first two principal components (PCs).

FIG. 6h is a box plot showing the Adjusted Rand Index score relative to noise.

FIG. 6i is a boxplot showing the uncertainty of task-specific groups of local minima, evaluated on batch of input data of the relevant task (in-distribution), and irrelevant task (out-distribution).

FIG. 7a is a statistical summary of the average test accuracy of all tasks relative to the number of seen tasks, for CIFAR-10 (left) and CIFAR-100 (right).

FIG. 7b is a boxplot showing accuracy of different models including the present embodiments (Driftnet), for CIFAR-10 (left) and CIFAR-100 (right).

FIG. 7c is a scatter dot plot showing lifelong learning accuracy relative to drift rate, for CIFAR-10 (left) and CIFAR-100 (right).

FIG. 7d is a boxplot showing lifelong learning accuracy relative to intrinsic noise level, for CIFAR-10 (left) and CIFAR-100 (right).

FIG. 7e is a boxplot showing drift rate relative to intrinsic noise level, for CIFAR-10 (left) and CIFAR-100 (right).

FIG. 7f shows graphs of accuracy of the present embodiments (Driftnet (high drift) and Driftnet (low drift) and Finetune as a function of tasks learned for five different tasks.

FIG. 7g is a scatter plot showing retrieval accuracy relative to drift rate, for CIFAR-10 (left) and CIFAR-100 (right).

FIG. 7h is a boxplot showing the retrieval accuracy relative to intrinsic noise, for CIFAR-10 (left) and CIFAR-100 (right).

FIG. 8 is a boxplot showing output variance for task-specific groups of local minima using data from the relevant task (In-distribution) and data from an irrelevant task (Out-distribution).

FIG. 9 is a boxplot showing clustering quality relative to the number of samples per task in the buffer, for CIFAR-10 (left) and CIFAR-100 (right).

FIG. 10 is a scatter plot showing the performance vectors of the minima, evaluated in the buffer, mapped to the first three principal components.

FIG. 11 is a boxplot showing lifelong learning accuracy relative to the number of saved local minima per task, for CIFAR-10 (left) and CIFAR-100 (right).

FIG. 12 is a bar graph showing the ratio of trainable parameters for the embodiments relative to lifelong learning baseline using a single network.

FIG. 13a is a schematic illustration of the embodiments applied to lifelong learning in language tasks.

FIG. 13b is a bar graph showing test accuracy on each task after sequential learning using three methods: the present embodiments (Driftnet), Oracle and Finetune.

FIG. 13c is a bar graph showing the difference in test accuracy between methods and Theoretical Limits for each of the four tasks during the learning process. Red boxes indicate the present embodiments' networks learning a new task with mild forgetting. Green boxes indicate Stable networks forgetting previous tasks.

FIG. 13d is a line graph showing average test accuracy across all tasks over the course of sequential learning for four methods: Joint, Oracle, Finetune, and the present embodiments (Driftnet).

FIG. 13e is boxplots showing final test accuracy relative to memory size across three pretrained LLMs.

FIG. 13f shows line graphs showing average test accuracy over the course of sequential learning using the pre-trained LLMs: Mistral-7B (left) and Deepseek-7b (right).

FIG. 14 shows a principal component analysis visualization of predictions of saved minima evaluated on familiar and unfamiliar data sets.

FIG. 15 shows boxplots showing the output variance of task-specific groups of local minima evaluated on input data relevant to the group's task and irrelevant to the group's task for three different large language models.

### DETAILED DESCRIPTION

To address catastrophic forgetting, current lifelong learning methods fall primarily into three categories: regularization, replay, and architectural methods. Regularization-based methods adjust neural network parameters for new tasks while constraining changes in crucial parameters of previous tasks by imposing constraints on training objectives, such as elastic weight consolidation (EWC) and synaptic intelligence (SI). Replay approaches, inspired by the experience replay during sleep in the hippocampus, typically involve training generators for all tasks or maintaining a sample buffer that stores data from previous tasks. When learning new tasks, data from previous tasks (either as pseudo-samples generated by the generators or as direct samples from the buffer) regularize the training objective. This replay helps to ensure that the performance on previous tasks experiences only minimal degradation. Replayed samples can also prevent gradient updates in crucial directions. Architectural strategies allocate new parameters for every task, which can be further divided into two subcategories: (1) fixed architecture, which uses a shared fixed network and trains a distinct set of parameters for every task, and (2) dynamic architecture, which sequentially expands the model structure for new tasks.

However, most existing architectural strategies require task identities or boundaries during both training and testing phases to be known. Deep learning studies have demonstrated that while these methods, such as the experience replay (ER) and the generative classifier, perform well on simpler tasks involving classify datasets such as MNIST and CIFAR-100 (with a feature extractor pre-trained in CIFAR-10), they struggle with more challenging tasks such as those involving Mini-ImageNet and CIFAR-100 without pre-trained information. This difficulty is due to the increasing complexity of the data distribution and the higher dimensionality. Experiments showed that regularization- and replay-based methods that train a single large network face difficulties in encoding new information without compromising existing knowledge.

This raises a fundamental question: What features of biological brains enable them to efficiently encode new information, retain previous knowledge, and effectively recall relevant information upon recurrence of a learned task? Although exact mechanisms remain unclear, recent biological research suggests that even as animals receive the same sensory input and maintain consistent performance on a task, their neural responses can undergo significant drift over time-a phenomenon termed neural representational drift. This phenomenon, once considered mainly as measurement artifacts, has been repeatedly confirmed by numerous long-term stable measurements in multiple regions of the brain enabled by advanced measurement techniques.

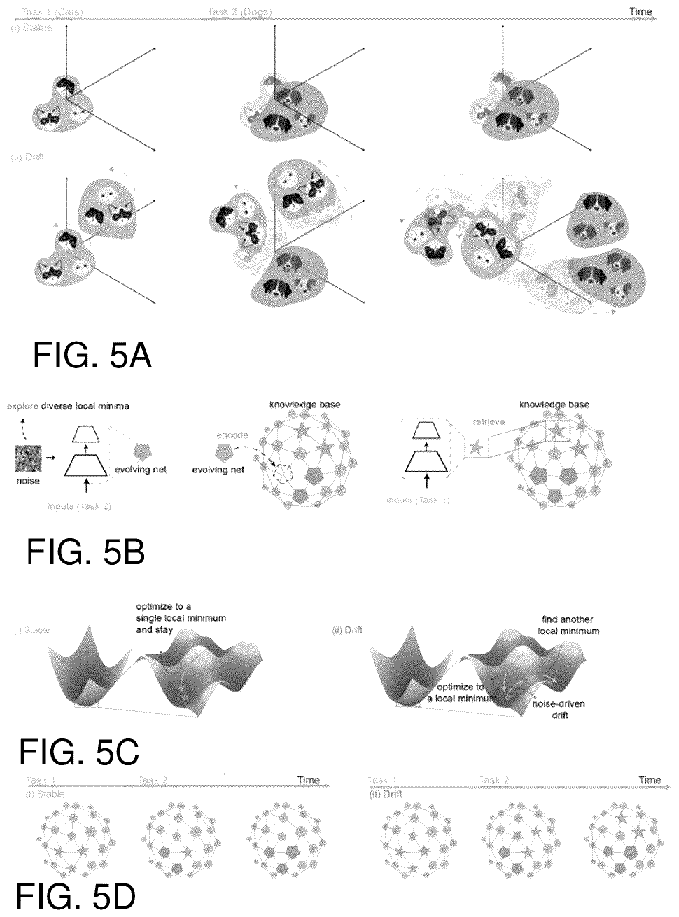

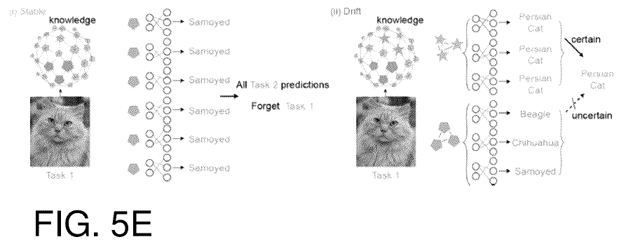

The present embodiments introduce drift into artificial neural networks (ANNs) to enable lifelong learning by reducing catastrophic forgetting of learned tasks. Although recent biologically inspired network experiments have suggested multiple mechanisms for implementing representational drift in ANNs, these have not been designed to improve lifelong learning capacity. To address this gap, we incorporate a drift mechanism that encourages continuous evolution of an ANN's weights and hidden representations, effectively exploring multiple low-loss regions within the loss landscape rather than settling into a single local minimum. This continuous exploration yields diverse solutions for each learned task, enriching the representational space and enhancing the network's capacity to continually acquire new knowledge and accurately retrieve previously learned information without relying on task identities or clear task boundaries. In contrast, conventional stable neural networks, whose weights remain fixed after convergence, cease to explore alternative minima, becoming trapped in a singular local solution. Consequently, when these stable networks encounter new tasks, their weight updates tend to overwrite previously established representations, resulting in catastrophic forgetting of earlier knowledge (FIG. 5a).

The present embodiments operate in three sequential stages: exploration, encoding, and retrieval. In exploration, externally induced stochasticity continuously drives the network's weights through diverse local minima, enriching task representations within the loss landscape. The resulting diversity enables the embodiments, during the encoding stage, to unsupervisedly cluster minima into distinct task-specific groups without requiring task identities or boundaries, where each group retains only a limited number of recent minima. Importantly, this grouping prevents overwriting of previously learned representations. Retaining a fixed, limited group size also ensures balanced memory usage, avoiding dominance by tasks encountered over longer durations. In the retrieval stage, the embodiments leverage this grouped diversity by evaluating output variance across stored task-specific groups of minima, selectively identifying confident predictions to achieve accurate knowledge recall. Collectively, continuous drift ensures robust preservation and precise retrieval of prior knowledge, enabling effective lifelong learning in dynamic environments.

The flow of the three stages is shown in Algorithm 1 below.

Algorithm 1 DriftNet

```
Input: Encode interval n_{enc} ∈ [symbol]   , buffer size n_{B}, the maximum group size of minima N_{group, max} ∈ [symbol]   ⁺.
  1: Initialize the evolving model M_{θ}_{ₜ} : [symbol]    ^{n×p} → [symbol]   ⁿ, knowledge base [symbol]   = ∅. grouping identities gr = [symbol]
    ^{|} [symbol]  | = ∅, and buffer [symbol]   = ∅.
  2: for t = 1,2,... do
  3:  Receive inputs Xₜ, and labels Yₜ.
  4:  Exploration step:
  5:  θₜ₊₁ ← NoisyUpdate(θₜ,Xₜ,Yₜ,σ).
  6:  Encoding step:
  7: [symbol]    ← BufferUpdate( [symbol]   ,Xₜ,Yₜ,t).
  8:  if t mod n_{enc} = 0 then
  9: [symbol]    ,gr ← Encode( [symbol]   ,θₜ, [symbol]   ).
10:  Retain at most N_{group, max} minima per group
11:  end if
12:  Retrieval step:
13:  if Receive test inputs xₜₑₛₜ then
14:  ŷₜₑₛₜ ← Retrieve( [symbol]   ,gr,xₜₑₛₜ).
15:  end if
16: end for
```

At any given time t, the embodiments consists of two main components: (1) an evolving model M_{θ}_{ₜ}, which is updated with noise to encourage exploration, and (2) a knowledge base [symbol] , which stores various local minima θₙ_{₁}, . . . , θₙ_{ₘ₍ₜ₎} learned from the evolving model, where the time indices 1≤n₁< . . . , nₘ₍ₜ₎≤t, and m(t): [0,∞)→ [symbol] denote the number of local minima at time t. These local minima of different tasks are grouped into task-specific groups, with grouping identities grₜ≙(gr_{t,1}, . . . , gr_{t,n}_{ₘ₍ₜ₎})∈ [symbol] ^{m(t)}, where the i-th stored minimum θₙᵢ belongs to the gr_{t,i}-th group, for i∈[m(t)].

During the exploration stage, the evolving model M_{θ}_{ₜ} is updated by injecting designed noise to facilitate the exploration of new solutions. During the encoding stage, the current state of the evolving model (treated as a local minimum) is stored for every given time interval. The stored local minima are then clustered into task-specific groups based on their performance, evaluated by a small buffer that stores previous data with equal probability. During the retrieval stage, the embodiments retrieve the output of the task specific group that exhibits the lowest uncertainty in its output for a given input.

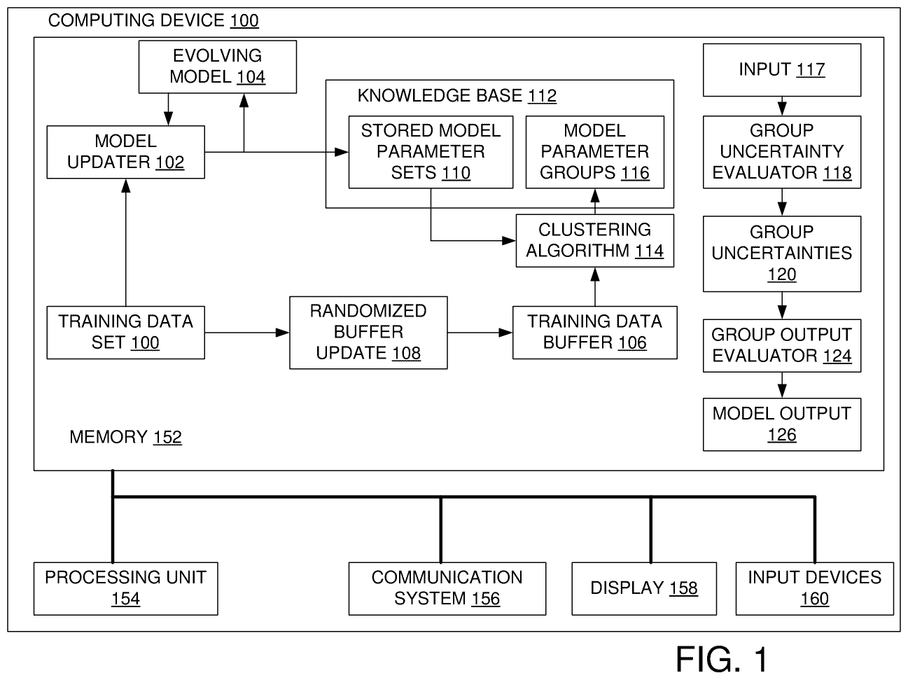

FIG. 1 provides a block diagram of a computing device 150 used to implement the three stages. Computing device 150 includes a memory 152, a processing unit 154, a communication system 156, a display 158 and input devices 160. Memory 152 contains executable instructions and data used to implement the three stages. Processing unit 154 executes the executable instructions and uses and generates data to implement the three stages. Processing unit 154 also receives input data and provides output values through communication system 156, input devices 160 and display 158. The executable instructions and data are described below in connection with flow diagrams of each stage.

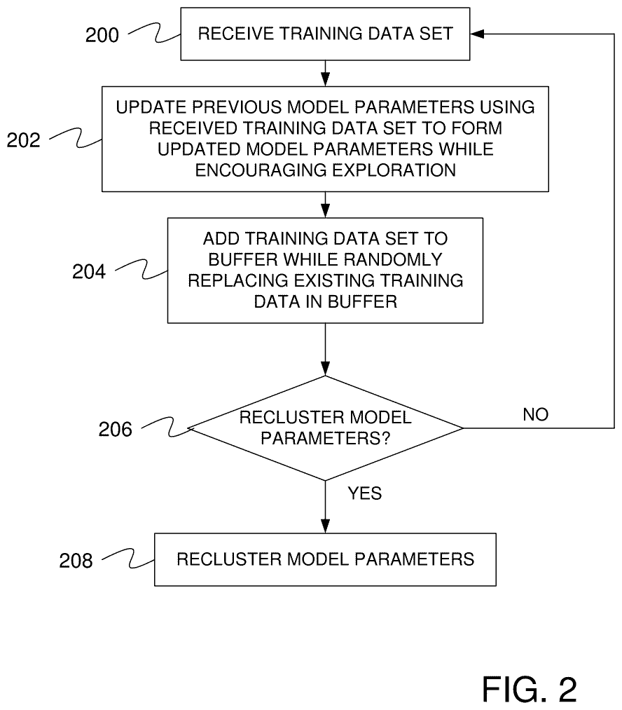

FIG. 2 provides a flow diagram of the exploration stage. In step 200, a training data set 100 of FIG. 1 is received. At step 202, a model updater 102 uses training data set 100 to update an evolving model 104 while encouraging exploration of local minima. This exploration is encouraged by adding noise during the updating.

There are three possible sources of noise that can be added during deep neural network training in step 202: batch sampling randomness, additive gradient noise, and additive input noise. Batch-sampling randomness occurs for all noise types as a subset of data is sampled to compute the gradient, reducing computational load in deep learning experiments. Additive gradient noise introduces Gaussian white noise into the gradient calculation, and additive input noise injects Gaussian white noise into the input data.

From a Bayesian perspective, the introduction of gradient noise serves as an approximate method for posterior sampling, similar to Stochastic Gradient Langevin Dynamics (SGLD). This controlled randomness prevents the network from too quickly converging to a single local minimum, promoting the exploration of multiple low-loss regions in the parameter space. As a result, the model is encouraged to diversify its learned representations, facilitating the discovery of various informative solutions across local minima. This noise-induced exploration enables the embodiments to continuously uncover diverse task-specific knowledge and robustly preserve previously learned tasks.

Algorithm 2 below summarizes the different ways that noise can be added during the update of model parameters θ.

Algorithm 2 Exploration step

```
Input: Noise Type type, learning rate η > 0, data X ∈ [symbol]   ^{n×p}, Yⁿ, and noise scale σ > 0.
  1: if type is “inputs” then
  2: X ← X + ε, where ε ~ [symbol]   (0, σ²Iₚ).
  3: end if
  4: g ← ∇_{θ}CrossEntropy(M_{θ}(X), Y).
  5: if type is “gradient” then
  6: g ← g + \tilde{ε}, where \tilde{ε} ~ [symbol]    (0, σ²I_{dim(θ)}).
  7: end if
  8: θ ← θ − ηg.
Output: θ
```

To further reduce memory cost and enhance efficiency, the present embodiments incorporate parameter-efficient fine tuning (PEFT) strategies. These include Adapter, which trains small adapters and Low-Rank Adaptation (LoRA), which restricts updates to low-rank matrices, thus limiting the number of parameters required to represent each iteration of the model.

The updated model parameters replace the existing model parameters of evolving model 104 to become the new evolving model 104.

At step 204, training data set 100 is added to a training data buffer 106 by a randomized buffer update 108. Algorithm 5 shows how the training data is added:

Algorithm 5 BufferUpdate

```
Input: Buffer [symbol]   , current data (Xₜ, Yₜ), current time step t
  1: if | [symbol]   | ≤ n_{B} then
  2: [symbol]   ← [symbol]   ∪ {(Xₜ, Yₜ)}
  3: else
  4: i ← RandInt([0,t])
  5: if i ≤ | [symbol]   | then
  6: [symbol]   [i] ← (Xₜ, Yₜ)
  7: end if
  8: end if
Output: [symbol]
```

As shown in Algorithm 5, if training data buffer 106 is not at its maximum size, n_{b}, yet, training data set 100 is simply added to training data buffer 106. If training data buffer 106 is at its maximum size, one of the sets of training data in training data buffer 106 is randomly selected and is replaced by training data set 100.

At step 206, the method determines if the encoding stage (clustering stage) is to be performed. In accordance with one embodiment, the encoding stage is only performed for every n^{th} set of training data that is received. In Algorithm 1, the number of training data sets received between encoding stages is indicated by n_{enc}.

If the encoding stage (clustering stage) is not to be performed at step 206, the process returns to step 200 to await the next set of training data. When the encoding stage is to be performed, the process continues at step 208 where the encoding/clustering of the model parameters is performed.

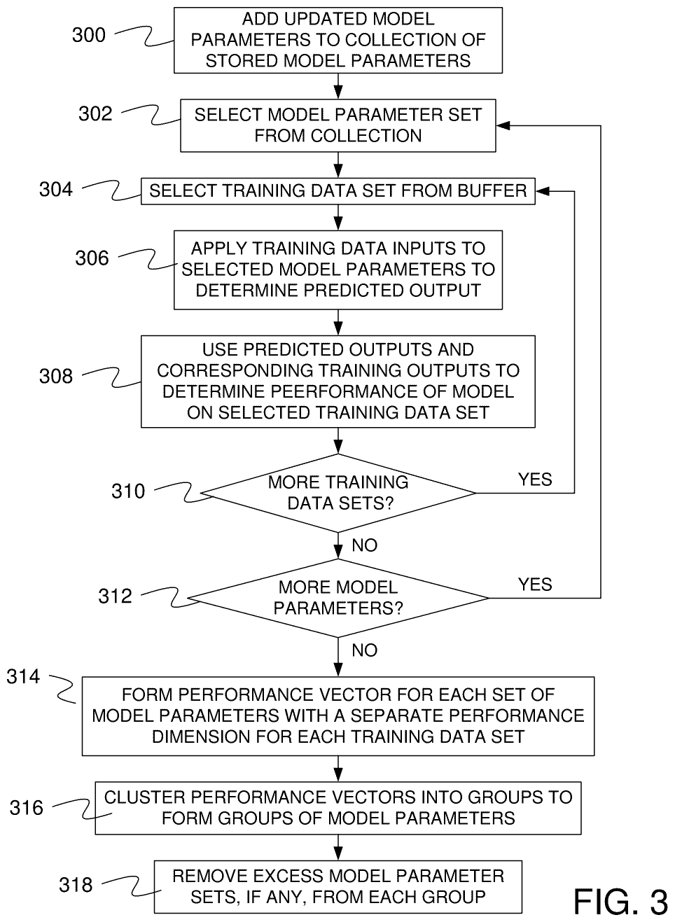

FIG. 3 provides a flow diagram of the encoding/clustering stage. At step 300, the updated model parameters of evolving model 104 are added to a collection of stored model parameters 110 in a knowledge base 112. Stored model parameters 110 do not include all of the model parameters set for evolving model 104 but instead only included the model parameters that were present when an encoding/cluster step was performed.

At step 302, one of the sets of model parameters in stored model parameters 110 is selected and at step 304, one of the sets of training data in training data buffer 106 is selected. At step 306, a clustering algorithm 114 applies the inputs of the selected training data set to the selected set of model parameters to produce a predicted output for each input. At step 308, clustering algorithm 114 uses the predicted outputs and the corresponding outputs in the selected training data set to determine the performance of the selected model parameters on the selected training data set.

At step 310, clustering algorithm 114 determines if there are more training data sets. If there are more training data sets, the next training data set in training data buffer 106 is selected by returning to step 306. Step 308 is then repeated for the newly selected training data set.

When all of the training data sets in training data buffer 106 have been applied to the selected model parameters, clustering algorithm 114 determines if there are more sets of model parameters in the collection of stored model parameters 110 at step 312. If there are more sets of model parameters, a different set of model parameters is selected by returning to step 302. Steps 302-310 are then repeated for the newly selected set of model parameters.

When all of the sets of training data in training data buffer have been applied to all of the sets of model parameters in stored model parameters 110, a performance value has been determined for each combination of training data set and model parameter set.

At step 314, these performance values are combined to produce a performance vector for each set of model parameters, where each performance vector has a separate dimension for the performance value of each set of training data. In other words, let knowledge base 112 contain model parameter sets M₁, . . . , Mₘ₍ₜ₎ at time t. We then create a performance vector (pvᵢ,i∈[m(t)]) for every model parameter set. Each performance vector is defined as pvᵢ≙(pv_{i,1}, . . . , pv_{i,n}), where

$${pv}_{i , j} {=}^{Δ} Criterion ( {M}_{i} ( {X}_{j} ) , {Y}_{j} ) ,$$

for i=1, . . . , m(t) and j=1, . . . , n, where Mᵢ(Xⱼ) is a vector of predicted outputs produced from the model parameters for an vector Xⱼ representing the inputs of the jth set of training data and Yj is a vector of the outputs of the jth set of training data. The Criterion function maps from a pair of predictions and actual outputs to real numbers. In accordance with one embodiment, the Criterion is the cross-entropy (See Methods below).

Once the performance vectors have been generated, clustering algorithm 114 clusters the performance vectors into groups at step 316. In accordance with one embodiment, the DBSCAN algorithm is used to cluster the performance vectors pv₁, . . . , pvₜ. DBSCAN is particularly useful because it does not require a pre-specified number of clusters, allowing the present embodiments to dynamically group the performance vectors to obtain the most accurate clustering. Once the performance vectors have been clustered, the clusters identified for the performance vectors are applied to the sets of model parameters associated with the performance vectors to produce model parameter groups 116. Thus, if performance vectors for model parameter sets A, C and D were clustered together, then model parameter sets A, C, and D would be clustered together in a model parameter group.

At step 318, clustering algorithm 114 removes excess sets of model parameters, if any, from each group. The number of model parameter sets within each group is controlled to prevent any single task from dominating the knowledge base, even if it is encountered frequently. This ensures that the embodiments balance knowledge across diverse tasks and avoids overfitting to any particular one. After step 318, model parameter groups 116 for this encoding stage are finalized.

The encoding stage of FIG. 3 is summarized in Algorithm 3 below:

Algorithm 3 Encoding step

```
Input: Knowledge [symbol]   , current parameters θₜ, batch data [symbol]   =
{(\tilde{X}₁, \tilde{Y}₁),...,
(\tilde{X}_{|} [symbol]  |, \tilde{Y}_{|} [symbol]  |)},
  1: [symbol]    ← [symbol]   ∪ {θₜ}
  2: for every \tilde{θ} ∈ [symbol]   do
  3: for j = 1 → | [symbol]   | do
  4: pv_{\tilde{θ}.j} ← CrossEntropy
        (M_{\tilde{θ}}(\tilde{X}ⱼ),
        \tilde{Y}ⱼ).
  5: end for
  6: end for
  7: gr ← Cluster({(pv_{\tilde{θ},1},...,pv_{\tilde{θ},|} [symbol]  |)
: \tilde{θ} ∈ [symbol]   }).
Output: [symbol]   . gr
```

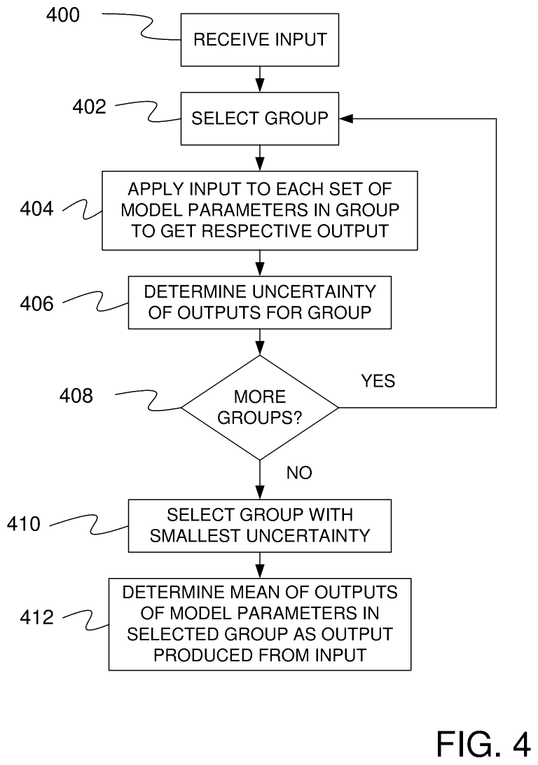

FIG. 4 provides a flow diagram of the retrieval stage during which the system provides an output for a received input using model parameter groups 116. During the retrieval stage, the embodiments select the group of model parameters from knowledge base 112 that exhibits minimal output variance/minimal output uncertainty.

In step 400, an input value 119 is received.

At step 402, a group uncertainty evaluator 118 selects one of the model parameter groups in model parameter groups 116. At step 404, the received input is applied to each set of model parameters in the selected model parameter group to produce a set of outputs. At step 406, group uncertainty evaluator 118 determines an uncertainty 120 for the group using the outputs. This uncertainty reflects the amount of difference between the outputs produced by the model parameter sets within the group. In groups with lower uncertainty, the sets of model parameters of the group predict similar outputs. However, in groups with higher uncertainty, the sets of model parameters of the group predict dissimilar outputs.

For classification problems, where the output or prediction vector of the j^{th} set of model parameters in the i^{th} group of model parameter sets is Ŷ_{i,j}ϵ [symbol] ^{c} and c is the number of classes, we consider the following output variance measures: entropy and variance of hard predictions.

1. Entropy: Measures the entropy of the averaged output predictions.

$$Entropy ( \frac{1}{{n}_{i}} {\sum }_{j = 1}^{{\tilde{n}}_{i}} {\hat{Y}}_{i , j} ) .$$

where ñᵢ is the number of model parameter sets in group [symbol] ᵢ.

2. Variance of hard predictions: Calculates the variance of the most likely class labels (hard predictions). For each prediction vector Ŷ_{i,j}, the hard label \tilde{Y}_{j,i}≙arg max (Ŷ_{i,j}) is the index of the class with the highest prediction probability. The variance is computed as:

$$Var ( {\tilde{Y}}_{i , 1} , … , {\tilde{Y}}_{i , {\tilde{n}}_{i}} ) ,$$

where \tilde{Y}_{j,i} is the hard label for each model parameter set in group [symbol] ᵢ. By evaluating these output variance measures, the embodiments select the group of model parameter sets that exhibits the lowest output variance, thus ensuring the most confident and accurate task-specific knowledge retrieval for the test input.

At step 408, group uncertainty evaluator 118 determines if there are more groups in model parameter groups 116. If there are more groups, a different group is selected by returning to step 402. Steps 404 and 406 are repeated for the newly selected group.

When a group uncertainty 120 has been determined for all of the groups at step 408, a group selection unit 122 selects the group with the smallest uncertainty at step 410. A group output evaluator 124 determines a mean of the outputs produced by the sets of model parameters in the selected group and this value is provided as the output 126 to the input 119 received at step 400.

Algorithm 4 below provides a summary of the retrieval stage.

Algorithm 4 Retrieval step

Input: Knowledge base [symbol] = {\tilde{θ}ₜ,...,\tilde{θ}_{|} [symbol] |}. group labels gr = (gr₁,...,gr_{|} [symbol] |), test input Xₜₑₛₜ
1: for i = 1 to max (gr) do
2: [symbol] ᵢ ← {\tilde{θ}ⱼ : grⱼ = i, j ∈ [| [symbol] |]}.
3: [symbol] ᵢ ← {M_{\tilde{θ}}(Xₜₑₛₜ) : \tilde{θ} ∈ [symbol] ᵢ}
4: uᵢ ← UncertaintyMeasure( [symbol] ᵢ)
5: end for
6: iₘᵢₙ ← argmin{u₁,...,u_{max (gr)}}
7: \tilde{y}ₜₑₛₜ ← Mean( [symbol] ᵢ_{ₘᵢₙ})

The embodiments' superior lifelong learning capabilities can be demonstrated across simulated data, image classification, and natural language processing (NLP) tasks. Critically, a strong positive correlation has been identified between drift rate and lifelong learning accuracy (e.g., CIFAR-100: r=0.95, R²=0.90, p<10⁻⁸¹).

Reducing intrinsic sampling noise significantly lowers drift rates and correspondingly decreases accuracy, whereas injecting external data noise effectively restores drift and enhances performance. The embodiments achieve average accuracies of 86.20%±0.33% on CIFAR-10 and 68.97%±0.33% on CIFAR-100, substantially outperforming a Stable baseline (19.18%±0.02% and 12.84%±0.07%, respectively), which retains only a single local minimum per task, and other established lifelong learning methods such as Experience Replay (40.43%±1.88% on CIFAR-10). Additionally, the embodiments effectively scale to large language models (Llama-3.1-8B, Mistral-7B and Deepseek-7B), substantially outperforming a standard fine-tuning baseline (which continually updates models on the current task; e.g., present embodiments: 68.96%±0.89%, Finetune: 19.44%±0.17% on Llama-3.1-8B). The present embodiments closely approach an idealized upper-bound (“Oracle”) scenario, which requires task identities (84.18%±0.19% on Llama-3.1-8B), while incurring minimal additional memory overhead (˜4.9% of parameters). Collectively, these results establish drift as a robust and scalable mechanism fundamentally enabling realistic lifelong learning without task identities or boundaries.

### Results

FIG. 1b presents an overview of the present embodiments showing a lifelong learning framework comprising two core components: (1) an evolving model for drift-induced exploration, and (2) a structured knowledge base for efficiently encoding and retrieving task-specific representations. The embodiments operate through three sequential steps: exploration of local minima, encoding of task-specific knowledge, and accurate knowledge retrieval.

First, inspired by the phenomenon of representational drift observed in biological neural systems, the embodiments employ controlled stochasticity to continuously drive the model towards diverse local minima within each task-specific loss landscape. This stochastic exploration is achieved through noise introduced by batch sampling in stochastic gradient descent (SGD), gradient perturbations, and Gaussian input perturbations. From a Bayesian perspective, the embodiment's exploration approximates posterior sampling akin to Stochastic Gradient Langevin Dynamics (SGLD), producing diverse, informative minima and substantially enriching task-specific representations (FIG. 5c).

Second, the embodiments encode the explored minima into task-specific groups without requiring task identities during training. Specifically, minima are grouped based on their performance patterns, such that minima associated with the same task exhibit superior performance on that task and differential performance on unrelated tasks. To maintain memory efficiency, the embodiments retain only a fixed number of the most recent minima per group, preventing tasks with longer training durations from disproportionately dominating the stored representations. Additionally, to further reduce memory overhead, especially in large language models (LLMs), the embodiments incorporate Parameter-Efficient Fine-Tuning (PEFT) strategies, such as Low-Rank Adaptation (LoRA), limiting the number of parameters required per local minimum.

Third, the embodiments accurately retrieve relevant task-specific knowledge during inference by leveraging the diversity of encoded minima resulting from drift-based exploration. Specifically, the embodiments evaluate the variance of predictions produced by the local minima within each task-specific group. The group with the lowest output variance is selected as the most relevant for retrieval (FIG. 5c).

### Benchmarking the Embodiments' Lifelong Learning Performance Using Simulated Datasets

To evaluate how representational drift enables the embodiments to mitigate catastrophic forgetting, we conducted experiments on two sequential linear regression tasks. These tasks were selected because their mathematical structure allows clear characterization of the loss landscape and multiple local minima (see Methods). Specifically, input variables (x1, x2, x3) were generated with the output defined as y=β₀*+β₁*x1+β₂*x2+β₃*x+ε, where ε˜N (0, 0.01) is Gaussian noise, and the model shifted from Task 1 to Task 2 by changing βᵢ* (i=0, . . . , 3). The input covariance matrix was singular, ensuring the existence of multiple distinct minima (see Methods).

In this experimental setting, the embodiments were implemented by injecting Gaussian white noise (mean 0, variance σ²I₄) into gradients during stochastic gradient descent (SGD). After each epoch (a single pass through the entire training dataset), we recorded model weights and employed DBSCAN clustering every 10 epochs to organize stored minima into task-specific groups based on output characteristics. During retrieval, the embodiments selected the task-specific group with minimal output variance for prediction. As a comparison, a stable baseline model was trained without noise injection, and its predictions averaged outputs from all stored weights.

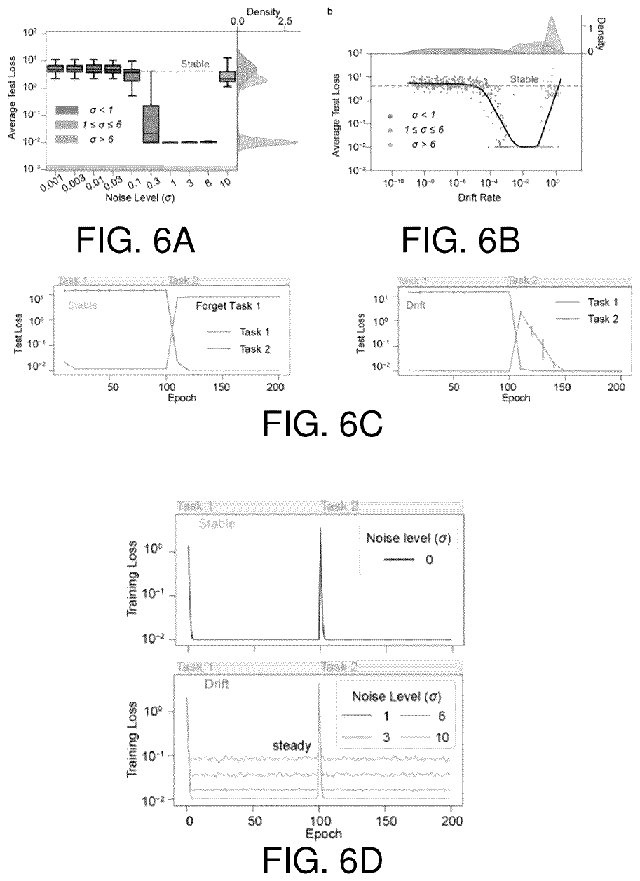

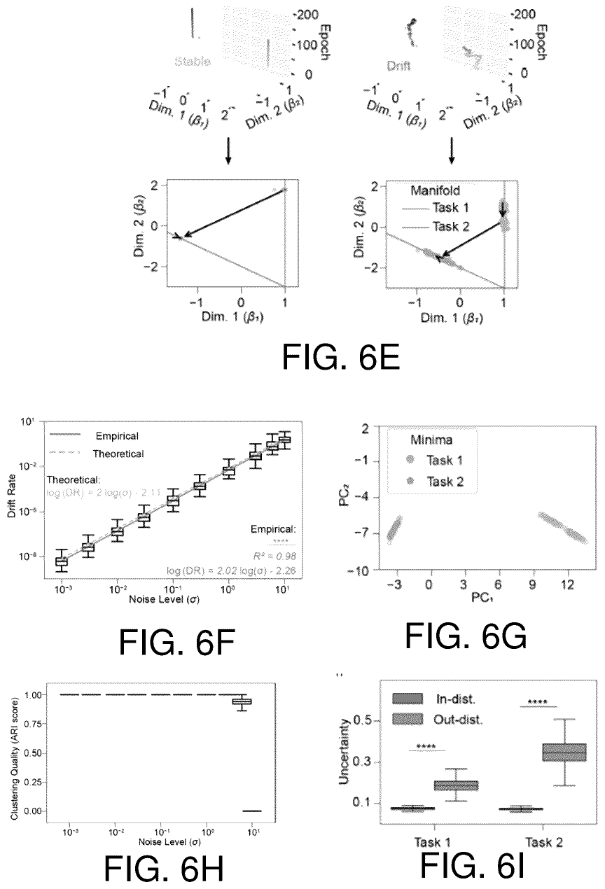

We found that the embodiments significantly outperformed the stable baseline in retaining task knowledge. After sequentially learning two tasks, the embodiments achieved an average test loss of (1.01±0.07)×10⁻² at noise level σ=3, substantially lower than the stable baseline's loss of 4.22±0.15 (FIG. 6a-b). This indicates that representational drift effectively preserves learned tasks by continuously exploring diverse local minima.

To further understand how drift contributed to this robust lifelong learning performance, we confirmed that injected noise consistently drove the network to actively explore local minima across various noise levels (σ=0 to 10). This drift did not harm learning; rather, the training losses remained stable (FIG. 6d), and model weights continued drifting across distinct minima (FIG. 6e). The drift rate increased proportionally with higher noise levels (FIG. 6f), demonstrating active and controlled exploration.

Critically, drift-induced exploration enabled the embodiments to effectively cluster local minima into separable task-specific groups without task identities (FIG. 6g). This grouping quality was quantitatively verified by a high adjusted Rand index (ARI>0.94±0.01 for moderate noise levels σ≤6; FIG. 6h).

We quantitatively demonstrated that diverse local minima from drift-based exploration facilitated accurate retrieval. The embodiments' retrieval accuracy significantly improved from chance-level (49.98±0.09% at σ=0.001, near random-guess) to high accuracy (94.36±1.79% at σ=0.3), maintaining stable accuracy within moderate noise levels (0.3≤σ≤6), before decreasing at very high noise (σ=10).

Moreover, results confirmed that local minima generated by drift produced significantly lower output variance for relevant (in-distribution) inputs compared to irrelevant (out-of-distribution) inputs (FIG. 6i). In-distribution output variances, (7.47±0.02)×10⁻² and (7.29±0.02)×10⁻², were significantly lower than out-of-distribution uncertainties, (1.88±0.01)×10⁻¹ and (3.50±0.02)×10⁻¹, with statistical significance (p<0.001, Student's t-test and Mann-Whitney U-test; see Methods). This directly illustrates how drift enhances accurate retrieval.

Drift-induced exploration of diverse local minima creates rich task-specific representations, enabling accurate retrieval and robust preservation of learned tasks, effectively preventing catastrophic forgetting.

The embodiments enhance lifelong learning performance in deep learning

To systematically evaluate the embodiments' lifelong learning capability in deep learning scenarios, we applied it to two standard image classification datasets, CIFAR-10 and CIFAR-100. We adopted a challenging class-incremental learning scenario, in which the model incrementally learns to classify an increasing number of object categories split into 5 subsets for CIFAR-10 and 10 subsets for CIFAR-100. During training, the embodiments leveraged intrinsic sampling noise inherent in stochastic gradient descent (SGD) and optionally injected external Gaussian data noise to induce drift, continuously exploring diverse local minima. These explored minima were grouped into task-specific clusters based on their performance characteristics. During retrieval, the embodiments identified the most relevant task-specific group by selecting the group with the lowest entropy of mean soft predictions. We compared embodiments' lifelong learning accuracy against several baseline methods: a Joint baseline (training simultaneously on all tasks), a Finetune baseline (sequential training without memory), a Stable baseline (retaining one local minimum per task), and an Oracle baseline (ideal performance assuming known task identities and perfect retrieval). Additionally, we compared the embodiments with state-of-the-art lifelong learning algorithms grouped by their requirement for task identities: (1) methods that do not require task identities, including Experience Replay (ER); (2) methods requiring task identities (or boundaries) only during training, including Generative Classifier (Gen) and Selection of Experts for Ensemble Diversification (SEED); and (3) methods requiring task identities during both training and testing, including Subspace Ensembles and Batch Ensembles. All experiments were conducted over 10 repetitions.

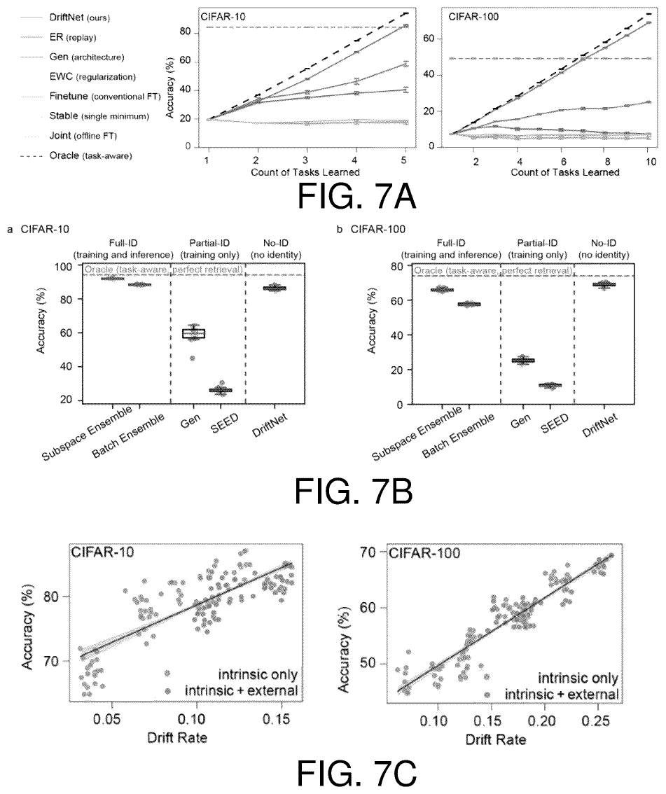

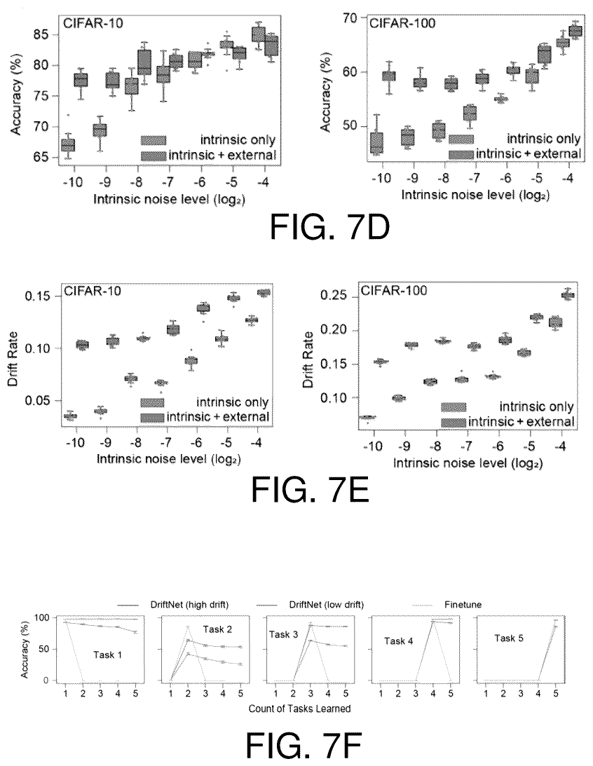

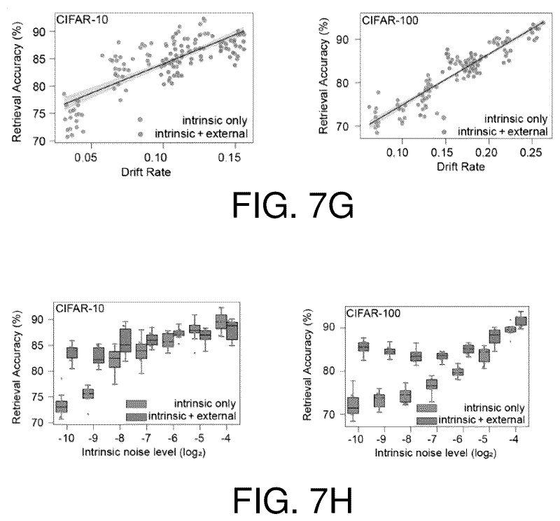

The embodiments demonstrated robust lifelong learning performance on both CIFAR-10 and CIFAR-100 (FIGS. 7a and 7b). Specifically, the embodiments reached an average accuracy of 86.20±0.33% (mean±SE) on CIFAR-10, approaching the Joint baseline (91.86±0.15%). The embodiments significantly outperformed methods that do not require task identities (ER: 40.43±1.88%; Finetune: 17.27±1.21%) and methods that require task identities only at training (Gen: 58.67±1.77%; SEED: 26.24±0.60%). A similar pattern was observed on CIFAR-100. Additionally, on CIFAR-100, the embodiments achieved 68.97±0.33% accuracy, outperforming even algorithms that depend on task identities at both training and inference, such as Subspace Ensemble (65.95±0.27%) and Batch Ensemble (57.59±0.23%), and closely approached the Oracle upper bound (73.91±0.11%).

To validate the role of representational drift in the embodiments' performance, we varied the drift rate by adjusting intrinsic sampling noise and optionally injecting external Gaussian data noise. We then assessed the direct impact of these variations on lifelong learning accuracy and retrieval accuracy (FIG. 7c-7f). The results revealed a strong positive correlation between drift rate and lifelong learning accuracy for both CIFAR-10 (r=0.83, R²=0.69, p<10⁻⁴⁰) and CIFAR-100 (r=0.95, R²=0.90, p<10⁻⁸⁰), indicating that increased drift rates significantly enhanced lifelong learning performance (FIG. 7b). Specifically, reducing intrinsic sampling noise lowered the drift rate and consequently degraded lifelong learning accuracy from 84.89±0.51% to 67.23±0.67% on CIFAR-10. Conversely, introducing external Gaussian data noise at a low intrinsic noise level (training batch size 1024) substantially increased the drift rate, thereby recovering high lifelong learning accuracy (FIG. 7c-d).

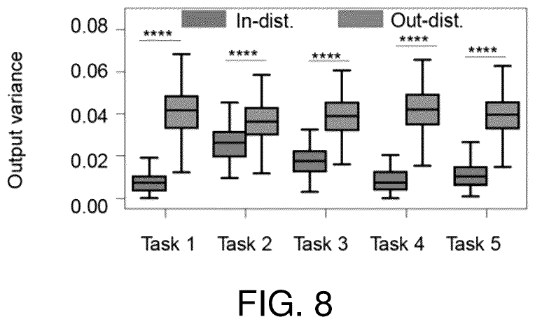

Furthermore, the embodiments accurately retrieved relevant knowledge when sufficient drift was present. Specifically, the embodiments consistently achieved high retrieval accuracy (above 80%) when the drift rate was greater than 0.1 for CIFAR-10 and greater than 0.18 for CIFAR-100 (FIGS. 7g and 7h). Moreover, predictions for in-distribution test inputs showed significantly lower output variance compared to out-of-distribution inputs, a difference confirmed statistically using Mann-Whitney U-tests and Student's t-tests (p-values<10⁻⁴ across all tasks; FIG. 8). These results demonstrate the effectiveness of the embodiments' retrieval mechanism with adequate drift.

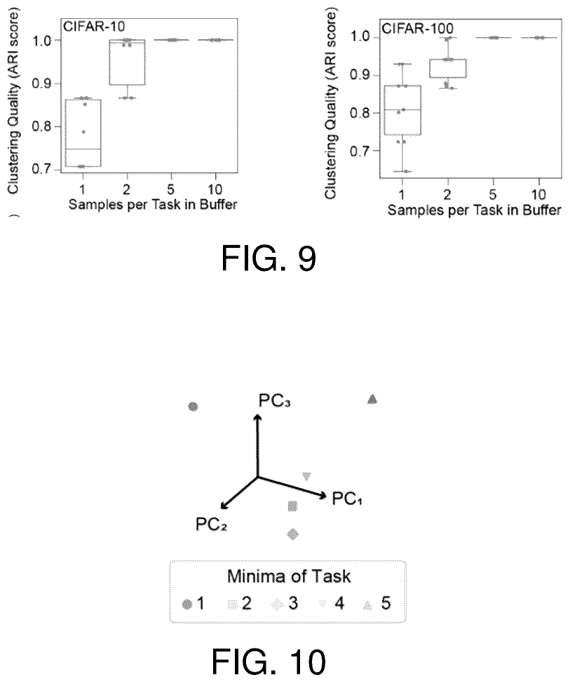

We next evaluated the embodiments' clustering accuracy under limited buffer sizes. The embodiments consistently achieved perfect clustering (Adjusted Rand Index=1.0) even when using small buffers (as few as five samples per task; FIG. 9). Visualization of performance vectors further confirmed clear task-specific separation (FIG. 10), suggesting DriftNet effectively clusters local minima, even under constrained conditions.

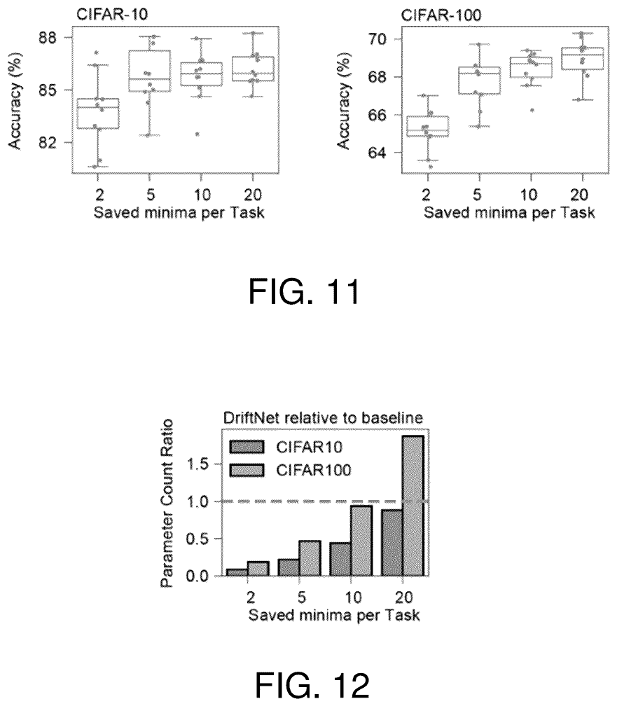

Lastly, the present embodiments maintained high lifelong learning accuracy under varying memory constraints. With memory budgets ranging from approximately 8.79% to 87.94% of the parameters used by ER, the embodiments' accuracy remained consistently high (83.77±0.66% to 86.20±0.33% for CIFAR-10; FIGS. 11 and 12). These results suggest that the embodiments achieve robust lifelong learning performance efficiently, and are resilient to variations in the total memory size, highlighting its practical applicability.

Taken together, these extensive experimental validations confirm that the embodiments achieve strong lifelong learning performance in image classification tasks with adequate representational drift.

The embodiments build effective lifelong learning large language models

Natural language processing (NLP) aims to enable machines to understand and generate human language. Recently, significant progress in NLP has been driven by advancements in large language models (LLMs), particularly with Transformer-based architectures utilizing self-attention mechanisms and powerful pre-trained language models. However, training entirely new models from scratch for each new NLP task remains prohibitively expensive. For example, training GPT-3, which contains 175 billion parameters, demands 3.14×10²³ floating-point operations (FLOP), translating to an impractical timeline of approximately 288 years on a single Nvidia V100 GPU60. Conversely, sequentially fine-tuning a pre-trained LLM on multiple tasks with shifting distributions commonly leads to catastrophic forgetting, severely degrading performance on previously learned tasks.

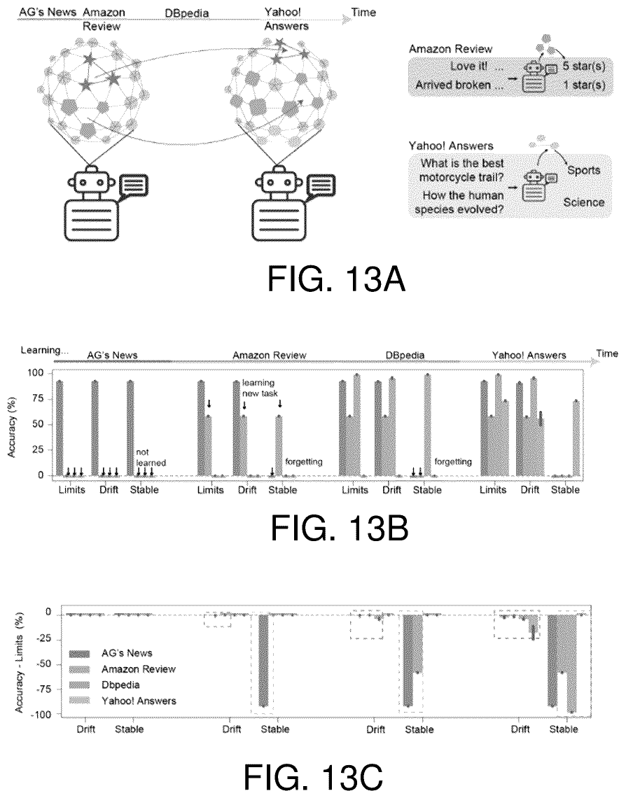

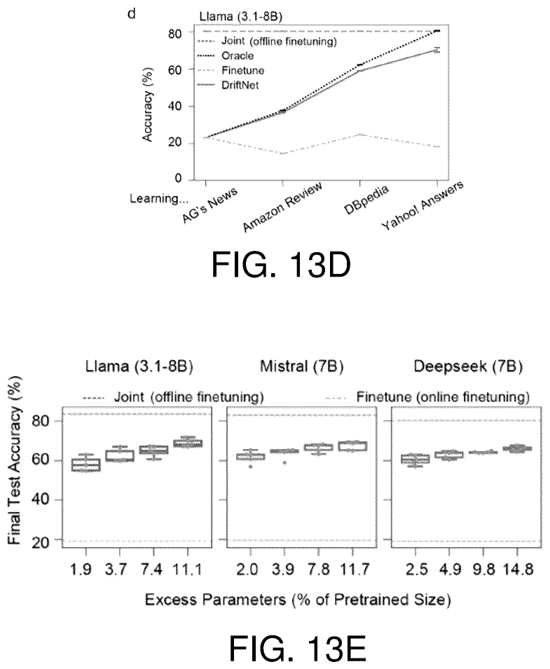

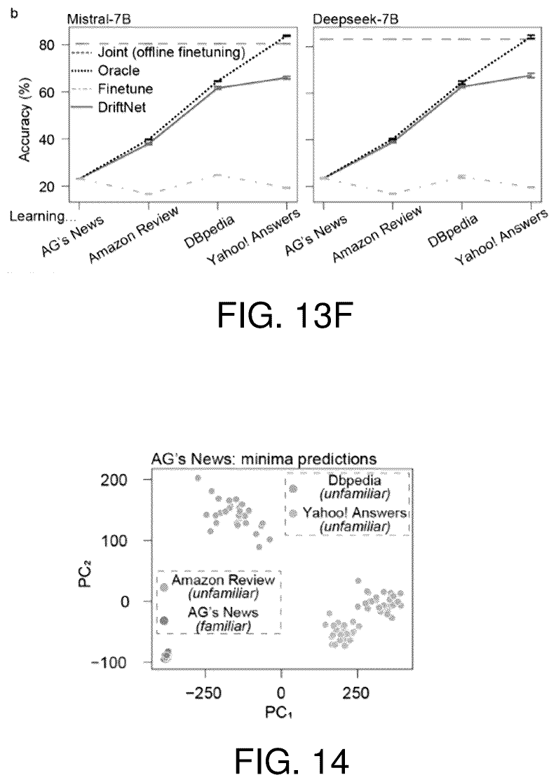

Given these challenges, we evaluated whether the present embodiments can efficiently and effectively support lifelong learning for state-of-the-art LLMs (FIG. 13a). Specifically, we integrated the embodiments with recent open-source LLM architectures: Llama-3.1-8B, Mistral-7B and Deepseek-7B. To enhance training efficiency, we employed a Parameter-Efficient Fine-Tuning (PEFT) technique, Low-Rank Adaptation (LoRA), allowing the embodiments to update only a small fraction (approximately 0.9%) of the original LLM parameters. Crucially, the embodiments do not require task identities during training or inference, which significantly enhances its practicality in real-world applications. We sequentially trained embodiments on four distinct NLP datasets: AG's News, Amazon Review Full, DBpedia, and Yahoo! Answers (see Methods).

The embodiments consistently demonstrated superior lifelong learning performance compared to standard fine-tuning (Finetune baseline) across different pretrained LLMs (FIG. 13b-d). Specifically, DriftNet achieved a significant performance improvement over the naive Finetune baseline on Llama-3.1-8B (68.96%±0.89% for the present embodiments, 19.44%±0.17% for Finetune), closely approaching the ideal Oracle scenario that assumes known task identities and perfect retrieval (84.18%±0.19%). This substantial performance advantage was consistently observed across other model architectures, including Deepseek-7B (Present embodiments: 65.98%±0.55%, Finetune: 19.29%±0.25%) and Mistral-7B (Present embodiments: 67.60%±0.98%, Finetune: 19.64%±0.26%; FIG. 13c), showing the scalability of the present embodiments across diverse LLM architectures.

Notably, the present embodiments maintained high performance with varied limited memory with only a small fraction (approximately 2% to 15%) of the original pre-trained LLM parameters. For instance, the present embodiments attained strong lifelong learning accuracy of 68.96%±0.89% on Llama-3.1-8B by saving only approximately 11.1% of the parameters, closely approaching the accuracy of Joint baseline, which updates 100% of the parameters simultaneously on all tasks (83.70%±0.14%; FIG. 13c). Furthermore, the present embodiments showed robustness under varying memory budgets (from approximately 3.7% to 11.1% of Llama-3.1-8B's parameters), maintaining consistently high accuracy (62.41%±1.47% to 68.96%±0.89%) for Llama-3.1-8B (FIG. 13c). Similar results hold for Mistral-7B and Deepseck-7B (FIG. 13f). This result highlights the embodiments' practicality for resource-constrained real-world applications.

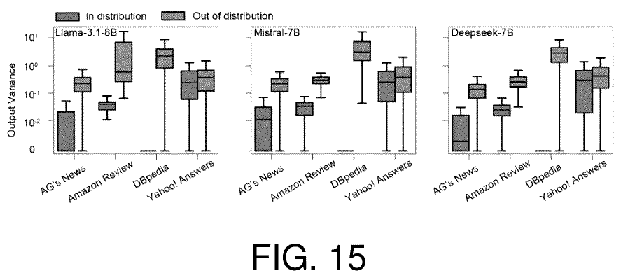

Additionally, the task-specific minima effectively differentiated relevant (in-distribution) task inputs from irrelevant (out-of-distribution) ones. Specifically, minima trained on AG News generated similar predictions for AG News' test dataset but made distinct predictions on unfamiliar test datasets (FIG. 14). This behavior was characterized by relatively low output variance on familiar test datasets and higher variance on unfamiliar ones (FIG. 15). This mechanism enabled the accurate retrieval of previously learned tasks without the need for task identities. These results highlight the embodiments' robust retrieval capabilities in lifelong learning, particularly for large language model (LLM) applications. Collectively, these findings indicate that the present embodiments, combined with parameter-efficient fine-tuning, can achieve promising accuracy and memory savings under realistic lifelong learning conditions. By adapting only a small fraction of the original LLM parameters and accurately retrieving past task information without task identities, the present embodiments demonstrate improved performance while remaining scalable and practical across diverse LLM architectures.

### Discussion

Incorporating representational drift into artificial neural networks provides a powerful mechanism to mitigate catastrophic forgetting in lifelong learning. Rather than converging to a single local minimum for each task, the embodiments maintain an evolving model that actively drifts through multiple local minima in the loss landscape. By continuously exploring and storing these diverse minima, the embodiments prevent overwriting of previously acquired knowledge while enabling efficient assimilation of new tasks, thus substantially enhancing its capacity for lifelong learning. Our experiments on image classification tasks (CIFAR-10 and CIFAR-100) show that the embodiments consistently achieve superior performance compared to standard finetuning and leading lifelong learning benchmarks. We further observe a strong positive correlation between the drift rate and the final average accuracy: little drift leads to inadequate exploration and poorer performance, whereas moderate drift substantially improves both memory retention and retrieval. Beyond these benchmark image classification experiments, we have also demonstrated that the embodiments extend effectively to large language models (LLMs). By pairing the embodiments drift mechanism with parameter-efficient fine-tuning techniques (such as LoRA), we show that only a small fraction of LLM parameters need to be updated and saved to achieve robust lifelong learning performance. The resulting system maintains its ability to recall previously learned tasks over potentially large model sizes, yet operates under a memory constraint of about 2% of the original pre-trained LLM. In addition, the method readily handles reoccurring or similar tasks without knowledge of task boundaries, confirming its suitability for realistic non-stationary language settings.

These results highlight how a continually drifting parameter space can balance plasticity and stability, two competing demands in lifelong learning. In particular, networks that continue exploring the parameter space maintain the flexibility to encode novel information without overwriting old knowledge, while also enabling accurate retrieval from the diverse range of solutions discovered along the way. This idea parallels with observed neural representational drift in biological systems, although its exact function in the brain remains an active topic. Our findings demonstrate that, in artificial networks, this principle of sustained exploration can be harnessed to reduce forgetting and strengthen the learned representation base.

Unlike traditional architecture-based approaches, which often mitigate catastrophic forgetting by training multiple experts and combining their outputs during inference, the embodiments operate without the need for task identities or boundaries. Methods such as SEED, Gen, Subspace Ensembles, and Batch Ensembles rely on task-specific knowledge or powerful feature extractors, which can be unrealistic for complex domains requiring large models. The embodiments, inspired by representational drift, continuously explore diverse local minima in the loss landscape, producing a rich pool of solutions that allows for efficient clustering and retrieval without requiring task boundaries. This ongoing drift generates diverse and informative representations, enabling the embodiments to efficiently utilize this information for task acquisition and retrieval during inference. Unlike methods with probabilistic components (such as SEED and Gen), which rely on strong feature extractors to produce low-dimensional embeddings, the embodiments directly store and reuse diverse local minima, offering a more robust and scalable solution to lifelong learning. This approach allows the embodiments to scale efficiently, even in LLMs, where traditional methods struggle with complex tasks and large model structures. By integrating parameter-efficient fine-tuning techniques such as LoRA, the embodiments reduce the size of each new minimum, enhancing scalability without sacrificing performance. This design ensures that the embodiments continually adapt to new tasks while preserving prior knowledge, providing a solution that avoids the scalability and catastrophic forgetting challenges that often hinder architecture-based methods in dynamic learning environments.

### Methods

### Definitions

Let N denote the set of all positive integers and R denote the set of all real numbers. Define [n]≙{1, . . . , n} for any n∈N. For a finite set A, let |A| denote its cardinality, namely the number of its elements. The argmax of a finite set A≙{a₁, . . . , a_{q}} is defined as:

$$arg max ( A ) {=}^{Δ} \{ i ∈ [ q ] : {a}_{i} = max ( A ) \} .$$

The entropy of a vector a≙(a₁, . . . , a_{q}), where

$${\sum }_{i = 1}^{q} {a}_{q} = 1 , {a}_{i} > 0$$

for i∈[q], is defined as:

$$entropy ( a ) {=}^{Δ} - {\sum }_{i - 1}^{q} {a}_{i} log {a}_{i} .$$

The indicator function [symbol] (E) for any event E is defined as [symbol] (E)=1 if E occurs and [symbol] (E)=0 otherwise. The modulo operation mod is defined as a mod b, which returns the remainder when a is divided by b. The dimension of the vector ω∈ [symbol] ^{C} (C∈ [symbol] ) is defined as dim(ω)≙C. For matrix A, we denote A^{τ} as the transpose of A.

### Lifelong Learning Formulation

In this section, we present the mathematical formulation of lifelong learning, which involves a learner sequentially encountering various tasks. Specifically, consider a time interval [Nᵢ+1,Nᵢ₊₁] of learning the τᵢ-th task (τᵢ∈N,i=1, . . . ), where Nᵢ<Nᵢ₊₁∈N⁺ and τ₁, . . . are not necessarily different. For any given time t within this interval, the learner processes data consisting of inputs Xₜ ∈X and outputs Yₜ∈Y, where the pair (Xₜ, Yₜ) is from an underlying data distribution [symbol] _{τi}. While classical lifelong learning (LL) assumes that transition points (N₁,N₂, . . . ) between tasks and task identities (τ₁, . . . ) are known, we consider a more realistic scenario where these are unknown. This situation is more challenging because the learner must infer the current task identity during training, which is particularly difficult when tasks can reoccur or exhibit similar data distributions. In this paper, we assume the inputs and labels are from [symbol] = [symbol] ^{p} and [symbol] = [symbol] , respectively.

### Task

Assume that the data with inputs X and labels Y in a task [symbol] are independent and identically distributed (i.i.d.) with respect to the distribution (X,Y)˜ [symbol] . For any two tasks [symbol] ₁ and [symbol] ₂, we consider them identical if and only if [symbol] (X, Y)= [symbol] (X, Y) for all X∈ [symbol] and Y∈ [symbol] . We focus on the scenario where each task appears only once, such that τᵢ=i for i∈ [symbol] .

### Test Accuracy

The lifelong learning capability of a learner is evaluated by its ability to learn new tasks without forgetting previously learned ones after training on k tasks. This is quantified by the average test accuracy in all k tasks, where the test accuracy of the i-th task is defined as:

$${Acc}_{i} {=}^{Δ} \frac{1}{\vert {𝒟}_{test , i} \vert} {\sum }_{( {X}_{test} , {Y}_{test} )} ( {\hat{Y}}_{test} = {Y}_{test} )$$

where [symbol] _{test,i} consists of data from i-th task, and Ŷₜₑₛₜ is the model prediction.

### Retrieval Accuracy

During the testing phase, given test inputs Xₜₑₛₜ from task τₜₑₛₜ, DriftNet retrieves a set of local minima {m₁, m₂, . . . , mₖ} that were trained on tasks {τ₁, τ₂, . . . , τₖ}, where k∈ [symbol] ⁺. We define the retrieval of relevant knowledge as successful if the majority of the retrieved local minima are relevant to the current task τₜₑₛₜ, expressed as:

$$r ( {X}_{test} , {τ}_{test} ) {=}^{Δ} 𝕝 ( {{\sum }_{j = 1}}^{k} 𝕝 ( {τ}_{j} = {τ}_{test} ) > \frac{k}{2} ) .$$

The retrieval accuracy of task τₜₑₛₜ is the average of r(Xₜₑₛₜ, τₜₑₛₜ) over all test inputs Xₜₑₛₜ from task τₜₑₛₜ.

The (overall) retrieval accuracy is the average retrieval accuracy across all tasks.

### Adjusted Rand Index (ARI)

The Adjusted Rand Index (ARI) is a measure of the similarity between two data groupings (partitions).

Let aᵢ (i=1, . . . , r) denote the number of observations from the i-th group of the first grouping and bⱼ (j=1, . . . , s) denote the number of observations from the jth group of the second grouping, where r,s∈N. Let nᵢⱼ (i=1, . . . , r, j=1, . . . , s) denote the number of observations from both the ith group of the first grouping and jth group of the second grouping. ARI is calculated by:

$$\frac{{\sum }_{ij} ( \begin{matrix}{n}_{i ,} \\ 2\end{matrix} ) - [ {\sum }_{i} ( \begin{matrix}{a}_{i} \\ 2\end{matrix} ) {\sum }_{j} ( \begin{matrix}{b}_{j} \\ 2\end{matrix} ) ] / ( \begin{matrix}n \\ 2\end{matrix} )}{\frac{1}{2} [ {\sum }_{i} ( \begin{matrix}{a}_{i} \\ 2\end{matrix} ) + {\sum }_{j} ( \begin{matrix}{b}_{j} \\ 2\end{matrix} ) ] - [ {\sum }_{i} ( \begin{matrix}{b}_{j} \\ 2\end{matrix} ) ] / ( \begin{matrix}n \\ 2\end{matrix} )} .$$

ARI takes values between −1 and 1. An ARI of 1 indicates perfect agreement between the two groupings, 0 indicates random labeling, and negative values indicate worse than random labeling.

### Criterion

The Mean Squared Error (MSE) loss evaluates regression model performance and is defined as:

$$\frac{1}{n} {{\sum }^{n}}_{j = 1} {( {Y}_{j} - {\hat{Y}}_{j} )}^{2}$$

where Yⱼ is the observed (actual) output value for the j-th sample, Ŷⱼ is its predicted value, and n is the sample size.

Cross-Entropy loss evaluates classification model performance. For multi-class classification with C classes, it is defined as:

$$- \frac{1}{n} {{\sum }_{j = 1}}^{n} {{\sum }_{i = 1}}^{C} {Y}_{jc} log ( {\dot{Y}}_{jc} ) ,$$

where Y_{jc} is a binary indicator (0 or 1) if the class label c is correct for sample j, and Ŷ_{jc} is the predicted probability that the sample j belongs to class c.
Student's t-Test and Mann-Whitney U-Test

To determine whether the measurements of the two groups are statistically different, we have employed both Student's t-test and Mann-Whitney U-test. Student's t-test was used to compare the means of two groups, assuming normally distributed data with equal variances. The t-statistic is calculated as:

$$t = \frac{{x}_{1} - {x}_{2}}{\sqrt{{S}_{p}^{2} ( \frac{1}{{n}_{1}} + \frac{1}{{n}_{2}} )}} ,$$

where

$${S}_{p}^{2} {=}^{Δ} \frac{( {n}_{1} - 1 ) s \text{?} + ( {n}_{2} - )}{{n}_{1} + {n}_{2} - 2} , {\overline{X}}_{1} and {\overline{X}}_{2}$$

$$\text{?} \text{indicates text missing or illegible when filed}$$

are the sample variances,

$${S}_{1}^{2} and {S}_{2}^{2}$$

are the sample means, and n₁ and n₂ are the sample sizes of the two groups, respectively. Under the null hypothesis, the t-statistic follows a t-distribution with n₁+n₂−2 degrees of freedom.

The Mann-Whitney U-test was used to determine whether two groups have different distributions. It ranks all data points from both groups and calculates the U statistic:

$$U = {n}_{1} {n}_{2} + \frac{{n}_{1} ( {n}_{1} + 1 )}{2} - {R}_{1} ,$$

where R₁ is the sum of the ranks for the first group, and n₁ and n₂ are the sample sizes of the first and second groups, respectively. Under the null hypothesis, the U statistic follows a distribution that can be approximated by a normal distribution when the sample size is large.

### Low-Rank Adaptation (LoRA)

Low-Rank Adaptation (LoRA) is a parameter-efficient technique for fine-tuning large pre-trained models.

Specifically, for a pre-trained large weight matrix W₀∈ [symbol] [symbol] . let ΔW be its update during the fine-tuning, that is, the updated weighted matrix is W₀+ΔW. LoRA constrains each update to have a low-rank representation:

$$Δ W = α BA ,$$

where B∈ [symbol] [symbol] and A∈ [symbol] [symbol] are low-rank matrices with rank r<<min(m,n), and α>0 is a scaling factor. During the entire training stage, the pre-trained weights W₀ are fixed while A and B are trainable parameters, thus requiring fewer trainable parameters. To produce predictions during the inference stage, the contribution of the low-rank matrices can be integrated into the updated weight matrix:

W=W₀+αBA.

### Spearman Rank Correlation

The Spearman rank correlation coefficient, denoted by ρ is a non-parametric measure of monotonic association between two variables. It relies only on rank ordering rather than raw numerical values of data. Given two paired sets of observations

$${\{ ( {x}_{i} , {y}_{i} ) \}}_{i = 1}^{n} ,$$

we first assign ranks R(xᵢ) and R(yᵢ) to each observation xᵢ and yᵢ, respectively. Formally, for each i=1, . . . , n, the rank R(xᵢ)∈{1, . . . , n} is defined as the position of xᵢ when the set {x₁, . . . , xₙ} is sorted in ascending order. Similarly, R(yᵢ)∈{1, . . . , n} is defined for the set {y₁, . . . , yₙ}. The Spearman rank correlation coefficient is then defined as the Pearson correlation between these ranks:

$$ρ {=}^{Δ} \frac{{\sum }_{i = 1}^{n} ( R ( {x}_{i} ) - \overline{R ( x )} ) ( R ( {y}_{i} ) - \overline{R ( y )} )}{\sqrt{{\sum }_{i = 1}^{n} {( R ( {x}_{i} ) - \overline{R ( x )} )}^{2}} \sqrt{{\sum }_{i = 1}^{n} {( R ( {y}_{i} ) - \overline{R ( y )} )}^{2}}} ,$$

where R̅(̅x̅)̅ and R̅(̅y̅)̅ denote the mean ranks of the x and y observations, respectively. Specifically,

$$\overline{R ( x )} {=}^{Δ} \frac{1}{n} {{\sum }_{i = 1}}^{n} R ( {x}_{i} ) , \overline{R ( y )} {=}^{Δ} \frac{1}{n} {{\sum }_{i = 1}}^{n} R ( {y}_{i} ) .$$

The Spearman coefficient ρ ranges between −1 and 1. Specifically, ρ=1 indicates a perfect positive monotonic relationship, ρ=−1 indicates a perfect negative monotonic relationship, and ρ=0 indicates no monotonic relationship. Because Spearman's correlation relies only on data ranks rather than raw numerical values, it is robust to outliers and invariant to monotone transformations of the data (e.g. logarithmic, exponential, or power transformations). Thus, it provides a stable measure of monotonic relationships and is well-suited for analyzing rank-order changes.

### Measures of Representational Drift

Feature Consider a neural network described by the composite mapping A_{α}ºB_{β}, where B_{β}: Rₚ→R^{q} and A_{α}: R^{q}→R^{c} for p, q, c∈N. For an input X∈R^{p}, define z≙B_{β}(X) as the output of B_{β}. The vector z is thus referred to as the feature of the network, expressing the learned internal representation of X.

Drift To quantify how features change over time, we define drift in the feature space. Let {z1, . . . , zn}⊆R^{q} be the set of feature vectors from n samples at time t, and {z′₁, . . . , z′ₙ}⊆R^{q} be the corresponding feature vectors at a later time t′. To capture the geometry of the feature space at these times, we first compute the pairwise Euclidean distances: for i, j=1, . . . , n,

$${D}_{ij}^{( t )} {=}^{Δ} {‖ {z}_{i} - {z}_{j} ‖}_{2} and {D}_{ij}^{( {t}^{′} )} {=}^{Δ} {‖ {z}_{i}^{′} - {z}_{j}^{′} ‖}_{2} .$$

These distances are organized into the n x n symmetric matrices D(t) and D(t′), respectively. Since the matrices are symmetric and the diagonal elements are zero, only the upper triangular part (excluding the diagonal) is considered in order to capture the unique geometric relationships. Thus, we define the vector of unique pairwise distances d(t)∈R^{m} by

$${d}^{( t )} {=}^{Δ} {[ {D}_{ij}^{( t )} : 1 \leq i < j \leq n ]}^{T} , m = \frac{n ( n - 1 )}{2} .$$

Similarly, for the matrix D^{(t)′} we form

$${d}^{( {t}^{′} )} {=}^{Δ} {[ {D}_{ij}^{( {t}^{′} )} : 1 \leq i < j \leq n ]}^{T} ∈ {m}^{} .$$

We then assess the change in the feature space by comparing the orderings of d^{(t)} and d^{(t′)} using the Spearman rank correlation coefficient. This approach focuses on the relative order of distances rather than their absolute values, and the drift is ultimately defined as drift=1−ρ, where ρ is the Spearman rank correlation between d^{(t)} and d^{(t′)}. A drift value near 0 indicates that the geometry of the feature space remains stable over time, whereas a value approaching 1 signifies substantial reordering and, consequently, significant representational change.

We specifically chose this rank-based measure due to several desirable properties. First, drift defined via Spearman rank correlation is invariant to uniform scaling or translation of feature vectors. Thus, this rank-based measure is robust against superficial changes in the absolute magnitude of features, which may arise due to varying normalization strategies or differences in training parameters. Second, rank-based metrics naturally emphasize structural changes rather than absolute differences. This aligns closely with our goal of measuring meaningful changes in the internal representational structure, rather than numerical artifacts. Lastly, rank correlation is robust against outliers and small subsets of points that may significantly influence metrics based on direct Euclidean distances, ensuring the drift measure captures genuine representational changes.

Drift Rate To capture the evolution of the feature space over multiple training timesteps, we define the drift rate. Suppose that features are recorded at consecutive checkpoints t⁽¹⁾, t⁽²⁾, . . . , t^{(K)}. Let ρ^{(k,k+1)} denote the Spearman rank correlation coefficient between the unique pairwise distances computed at t^{(k)} and t^{(k+1)}. The drift rate over the training period is given by:

$$\overline{drift rate} = \frac{1}{K - 1} {\sum }_{k = 1}^{K} ( 1 - {ρ}^{( k , k + 1 )} ) .$$

This scalar quantifies the average change in the internal geometry of the network's feature space per time interval. A low drift rate implies stable internal representations across training, while a high drift rate indicates rapid evolution of the learned features.

The drift rate provides a metric for comparing representational stability across training conditions or network architectures. By averaging incremental drift values, it smooths transient fluctuations. Since drift and drift rate rely on rank-ordered pairwise distances, they reflect fundamental structural changes in feature geometry, rather than numerical variations or noise, offering reliable insights into representational dynamics during training.

### Lifelong Learning Baselines

In this section, we briefly introduce the comparison baselines. The titles provided are the abbreviations used herein.

Fine-tune The Fine-tune baseline continuously updates a single model using gradient descent in the current batch. This method does not retain information from previous tasks and relies solely on the current data. As a result, it provides a naive baseline, highlighting the model's performance without any mechanisms for retaining or recalling past knowledge.

Joint The Joint baseline trains a single network on the combined dataset of all tasks, treating it as a single large task. This approach requires access to all data simultaneously, which is often not feasible in real-world scenarios. It serves as a performance benchmark, representing the upper limit of what could be achieved when test task identity is unknown with offline data and perfect memory.

Stable The Stable baseline trains a single network continuously, saving a checkpoint after each task. At test time, it averages the predictions of all saved checkpoints to produce the final output. The Stable baseline represents a no-drift scenario.

Oracle Oracle baseline maintains a set of distinct models, one for each task. During both training and inference, the task identity is provided, allowing the model to use the corresponding task-specific network for label prediction. It is unfeasible in practice and serves as an upper bound for performance, demonstrating the best possible outcomes when task identities are known.

Gen Generative classifiers (Gen) maintain a set of tuples, each consisting of a classifier and a generator, such as a Variational Autoencoder (VAE). The model has one tuple of generator and classifier per task. During training, the task identity is provided, and the corresponding tuple is updated based on the current batch. In the inference phase, the generators assist in selecting the appropriate classifier. The classifier associated with the generator that produces the lowest loss in inputs is chosen, using generative models to enhance classification performance.

ER Experience Replay (ER) is an effective baseline in lifelong learning that operates without the need for known task identities. ER uses Reservoir Sampling to maintain a buffer, ensuring that each data point is stored with equal probability. During training, the model is updated by integrating the current data batch with a batch sampled from this buffer. This approach helps mitigate catastrophic forgetting by revisiting past experiences during the learning process.

Subspace Ensemble Subspace Ensemble maintains an ensemble of multiple models, each of which is trained on a distinct low-dimensional parameter subspace. This approach reduces training overhead by requiring only a single backpropagation pass per subspace. Although Subspace Ensemble provides an efficient method to maintain multiple specialized models, it relies on task identities during inference to select the corresponding ensemble. Therefore, this makes it less applicable when task boundaries are not known in advance.

Batch Ensemble Batch Ensemble is an efficient ensembling method that shares most model parameters (referred to as “slow weights”) among ensemble members, while introducing rank-one adaptations (“fast weights”) for each member. This design reduces computational and memory overhead, compared to standard ensembles. However, similar to Subspace Ensemble, Batch Ensemble also requires knowledge of task identities at inference time to determine which subset of fast weights to combine with the shared slow weights.

SEED Selection of Experts for Ensemble Diversification (SEED) employs multiple neural-network experts with known task boundaries during training. Every expert consists of a fixed feature extractor and Gaussian distribution classifiers that are updated for subsequent tasks. The feature extractor is trained only on the first task and thereby frozen. Inference proceeds by combining predictions based on Gaussian log-likelihoods for each class.

Simulation We generated simulated datasets for two linear regression tasks with inputs (x₁,x₂,x₃) and labels

$$y = {β}_{0}^{*} + {β}_{1}^{*} {x}_{1} + {β}_{2}^{*} {x}_{2} + {β}_{3}^{*} {x}_{3} + ε ,$$

where ε˜N (0,0.01). Specifically, the two tasks were as follows: (1) for the first task, x₂=0, (x₁,x₃)˜N (0,I₂), and

$$( {β}_{0}^{*} , {β}_{1}^{*} , {β}_{2}^{*} , {β}_{3}^{*} ) = ( 0 , 1 , 1 , 1 ) .$$

(2) for the second task, x₂=x₁, (x₁,x₃)˜N (0,I₂), and

$$( {β}_{0}^{*} , {β}_{1}^{*} , {β}_{2}^{*} , {β}_{3}^{*} ) = ( 0 , - 1 , - 1 , - 1 ) .$$

Therefore, the theoretical manifolds of local minima for the two tasks are (0,c, 1,1): cε [symbol] and (0,c,−2-c,−1): c∈ [symbol] , respectively. Each task contained 10,000 samples and was iterated 100 times (100 epochs per task) with batch size 16.

We trained DriftNet using the model y=β₀+β₁x₁+β₂x₂+β₃x₃, with stochastic gradient descent (SGD) with a learning rate of 0.001. Gaussian noise with mean 0 and variance σ²I₄ was added to each gradient during training, similarly to theoretical proposals for representational drift and stochastic Langevin gradient descent. We maintained a buffer storing 10 randomly picked batches for every learned task, and then evaluated performance vectors of all stored weights every 10 epochs, with an epoch being a single pass through the entire training dataset. The network parameters were stored at the end of each epoch. A buffer was maintained, which stored 10 random batches per task. Every 10 epochs, each stored minimum was evaluated in the buffer using a 0-1 metric, where a value of 1 indicated that the squared test loss exceeded three times the standard deviation of ε (0.03). The DBSCAN algorithm, with cosine distance and a hyperparameter ε=1, was applied to group the stored local minima. During retrieval, given a test input, the variance of the outputs within the same group was regarded uncertainty. The group with minimal uncertainty was selected to provide the output. In contrast, for the stable baseline as a control, the weights were stored similarly at each epoch, and the average output from all stored weights was used for any test inputs. This baseline approach did not involve noise injection during training and served to highlight the differences in performance and robustness compared to the present embodiments. Experiments were conducted with 50 repetitions for the simulated datasets.

### Image Classification

For approaches training a single model, including Finetune, Joint, and ER, we employed ResNet-18 with 64 initial filters and 2 blocks. For approaches involving one model per task, including Oracle, Stable, SEED and Gen, we used a reduced version of ResNet-18 with initial filters 20 and 2 blocks, as in work. Specifically, for methods involving multiple models per task (Subspace Ensemble, Batch Ensemble and the present embodiments), we use reduced version of ResNet-18 with initial filters 9 and 1 block. Furthermore, we used a CNN-based VAE with two 3 x3 convolutional layers in the encoders with a 3x3 kernel, a padding of 1, and a stride of 1 (first layer) or 2 (all other layers). For all methods and datasets, the training batch size was set to 16, and the AdamW optimizer was used with a learning rate of 0.001, β of (0.9,0.999), and a weight decay of 0.01, unless otherwise specified.

For the present embodiments, we varied the training batch size across the set {8, 16, 32, 64, . . . , 1024}. Additionally, we explored the effect of injecting Gaussian noise into input data. Specifically, each input was augmented with additive Gaussian noise drawn from a distribution N (0, 0.1²) with probability 0.5. The network parameters were saved every 10 epochs in default. A reservoir buffer of size 50 was maintained over time to store previous data samples uniformly. We applied the DBSCAN algorithm to group all stored local minima, using a hyperparameter ε=0.5 (the maximum distance between two samples to be considered neighbors) and the cosine distance for the grouping. During testing, the batch size was maintained at 16, identical to the training batch size. ER used a reservoir buffer of size 2000 for CIFAR-10 and 5000 for CIFAR-100, respectively.

### Natural Language Processing

We selected four datasets for our experiments, sequentially learning from each dataset: AG's News, Amazon Review Full, DBpedia, and Yahoo! Answers:
AG's News: This dataset contains 496, 835 categorized news articles classified into four largest classes: World, Sports, Business, and Science/Technology. The number of training samples for each class is 30,000, with 1,900 testing samples per class.
Amazon Review Full: This sentiment analysis dataset contains reviews on products with ratings from 1 to 5 stars. It includes 600,000 training samples and 130,000 testing samples per class for the full score prediction.
DBpedia: This dataset is a community effort to extract structured information from Wikipedia. It includes 14 nonoverlapping classes from DBpedia 2014, such as Animal, Plant, Album, and Film. Each class has 40,000 training samples and 5,000 testing samples.
Yahoo! Answers: This topic classification dataset contains 10 topics, including Society & Culture, Science & Mathematics, and Health. Each class contains 140,000 training samples and 5,000 testing samples.

In our experiments, we evaluated the present embodiments using several open-source pre-trained large language models (LLMs): Llama-3.1-8B, Mistral-7B, and Deepseek-7B. We employed Low-Rank Adaptation (LoRA), a parameter-efficient fine-tuning technique, with hyperparameters set as follows: rank r=16, scaling factor α=32, and dropout probability p=0.5.

Each task was trained using SGD for 5 epochs, with a batch size of 8. We utilized a cyclic learning rate scheduler, linearly varying the learning rate between 10⁻⁵ and 10⁻², cycling 10 times per epoch. To ensure model stability and avoid cold-start issues, we saved the network parameters at the lowest learning rate since the third epoch. Additionally, to encourage diversity in model solutions, we combined cross-entropy loss with label smoothing (ε=0.1) and an entropy regularization term, specifically:

$${Loss}_{final} {=}^{Δ} {Loss}_{CE - smoothed} - 0.01 \times {H}_{avg} ,$$

where Loss_{CE-smoothed} denotes the cross-entropy loss with smoothed targets (ε=0.1)

$${y}_{i , c}^{( ε )} {=}^{Δ} ( 1 - ε ) {y}_{i , c} + \frac{ε}{C} ,$$

where y_{i,c} is the true label (one-hot encoded) for sample i and class c, and C is the number of classes. Additionally, H_{avg} represents the average prediction entropy across samples in the batch:

$${H}_{avg} {=}^{Δ} - \frac{1}{N} {\sum }_{i = 1}^{N} {\sum }_{c = 1}^{C} {p}_{i , c} log ( {P}_{i , c} ) .$$

This loss penalizes overconfident predictions by applying label smoothing and discourages overly concentrated predictions through the entropy regularization term.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
receiving data;
while using a process that promotes exploration during training, training a new set of model parameters using the received data;
placing the new set of model parameters in a collection of previous sets of model parameters to form a new collection of sets of model parameters;
applying a set of data separately to each set of model parameters in the new collection of sets of model parameters to identify sets of model parameters that perform similarly on the set of data;
grouping the sets of model parameters that perform similarly on the set of data together in a group of sets of model parameters;
applying test data to groups of sets of model parameters to obtain an uncertainty measure for each group;
selecting a group with the lowest uncertainty measure; and
using outputs produced by the sets of model parameters in the selected group to generate an output value for the test data.

2. The computer-implemented method of claim 1 wherein using a process that promotes exploration during training comprises adding noise to the received data.

3. The computer-implemented method of claim 1 wherein applying a set of data separately to each set of model parameters comprises applying a set of data used to train one of the previous sets of model parameters.

4. The computer-implemented method of claim 1 wherein training a new set of model parameters using the received data comprises updating a previous set of model parameters using the received data.

5. The computer-implemented method of claim 1 wherein each set of model parameters in the collection of sets of model parameters is trained using respective data associated with a respective unknown task.

6. The computer-implemented method of claim 5 wherein at least two of the sets of model parameters in the collection of sets of model parameters is trained using respective data associated with a same unknown task.

7. The computer-implemented method of claim 1 wherein using outputs produced by the sets of model parameters in the selected group to generate an output value comprises determining a mean of the outputs to generate the output value.

8. A method of improving an artificial intelligence system so that the system performs well on a new task without forgetting how to perform an old task, the method comprising:
while using a process that promotes exploration during training, training a new set of model parameters using data for the new task;
grouping the new set of model parameters with prior sets of model parameters to form a group of sets of model parameters, wherein the grouping is based on similarities in performance between the new set of model parameters and the prior sets of model parameters; and
applying an input to each set of model parameters in the group of sets of model parameters to produce a set of outputs and using the set of outputs to determine a final output for the artificial intelligence system.

9. The method of claim 8 wherein using a process that promotes exploration during training comprises adding noise to the data for the new task.

10. The method of claim 8 wherein using a process that promotes exploration during training comprises adding noise to a prior set of model parameters to form a modified set of model parameters and updating the modified set of model parameters using the data for the new task to form the new set of model parameters.

11. The method of claim 8 wherein using a process that promotes exploration during training comprises adding gradient noise when training the new set of model parameters.

12. The method of claim 8 wherein the identity of the new task is unknown.

13. The method of claim 8 further comprising forming a plurality of groups of sets of model parameters.

14. The method of claim 13 further comprising selecting one group of the plurality of groups by applying the input to each set of model parameters in each group and determining which group provides a most-consistent output.

15. The method of claim 13 wherein forming the plurality of groups of sets of model parameters comprises applying data used to form at least some of the sets of model parameters and forming the groups based on the outputs of the sets of model parameters.

16. A system comprising:
a memory containing sets of model parameters;
a processor configured to perform steps comprising:
while using a process that promotes exploration during training, training a new set of model parameters using data;
grouping the new set of model parameters with prior sets of model parameters to form a group of sets of model parameters, wherein the grouping is based on similarities in performance between the new set of model parameters and the prior sets of model parameters; and
applying an input to each set of model parameters in the group of sets of model parameters to produce a set of outputs and using the set of outputs to determine a final output.

17. The system of claim 16 wherein using a process that promotes exploration during training comprises adding noise to the data for the new task.

18. The method of claim 16 wherein using a process that promotes exploration during training comprises adding gradient noise when training the new set of model parameters.

19. The method of claim 16 further comprising forming a plurality of groups of sets of model parameters.

20. The method of claim 19 further comprising selecting one group of the plurality of groups by applying the input to each set of model parameters in each group and determining which group provides a most-consistent output.
